(19) United States
(12) Patent Application Publication
(10) Pub. No.: US 2006/0153102 A1
(43) Pub. Date: Jul. 13, 2006

(54) Multi-party sessions in a communication system

(75) Inventors: Pekka Kuure, Espoo (FI); Tapio Paavonen, Pirkkala (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/100,547

(22) Filed: Apr. 7, 2005

(30) Foreign Application Priority Data
Jan. 11, 2005 (GB) 0500483.3

(51) Int. Cl. H04L 12/16

(52) U.S. Cl. 370/263

(57) ABSTRACT

A controller for controlling a multiparty session in a communication system and a method for is disclosed. The controller comprises a control function configured to host a multiparty session. The control function controls joining of parties to the multiparty session and also selects at least one communication parameter based on discovered capabilities of the parties to the multiparty session. After the selection, information regarding the selected at least one communication parameter is sent to at least one party of the multiparty session.

### BACKGROUND OF THE INVENTION

1. Field of the Invention

The present invention relates to a communication system and in particular but not exclusively to handling set-up of multi-party sessions in a communication system.

2. Description of the Related Art

A communication system can be seen as a facility that enables communication sessions between two or more entities such as user equipment or other nodes associated with the communication system. The communication may comprise, for example, communication of voice, data, multimedia and the like. A session may, for example, be a telephone call type session between two users, a multi-party session, for example a conference call, or a communication session between at least one user and an application server (AS) such as a service provider server.

A communication system typically operates in accordance with given standards and/or specifications, which set out what the various entities associated with the communication system are permitted to do and how that should be achieved. For example, a standard or specification may define if the user, or more precisely, user equipment is provided with a circuit switched service and/or a packet switched service. Communication protocols and/or parameters, which shall be used for the connection may also be defined. In other words, a specific set of rules on which the communication can be based is defined to enable communication.

Communication systems providing wireless communication for user equipment are known. An example of a wireless system is the public land mobile network (PLMN). PLMNs are commonly based on cellular technology. In cellular systems, a base transceiver station (BTS) or similar access entity services mobile user equipment (UE) via a wireless interface between these entities. The communication on the wireless interface between the user equipment and elements of the communication network can be based on an appropriate communication protocol. The operation of the base station apparatus and other apparatus required for the communication can be controlled by one or several control entities. The various control entities may be interconnected. One or more gateway nodes may be provided for connecting the cellular access network to other networks, for example to a public switched telephone network (PSTN) and/or other communication networks such as an IP (Internet Protocol) and/or other packet switched data networks. In such arrangements, the mobile communications network provides an access network enabling a user with wireless user equipment to access external networks, hosts, or services offered by specific service providers.

In a packet data network, a packet data carrier may be established to carry traffic flows over the network. An example of such a packet data carrier is a packet data protocol (PDP) context.

Various types of services are provided by means of different application servers (AS). An example of a service that may be provided by means of applications server is the so-called direct voice communication service, a more particular example of this type of services being the ‘push-to-talk over cellular’ (PoC) service also known as the PTT (push-to-talk service). The direct voice communication services are intended to enable Internet Protocol (IP) connections for user equipment and other parties to the communication, such as other user equipment or entities associated with the network. The service allows users to engage in immediate communication with one or more users.

The principle behind push-to-talk over cellular (PoC) communication systems is one where the capabilities of a walkie-talkie system are implemented within a standard cellular phone. Users simply select the person or groups of persons they wish to talk to from their phone and press the push to talk key on their mobile phone to start talking. The activation may be via a specific button, tangent or any other appropriate actuation means, such as a key of the keyboard. Similar principals apply with devices having touch sensitive or sound activated user interfaces.

While the user speaks, the other user or users may listen. Push-to-talk calls are typically half-duplex communications, i.e. while one user speaks the others listen. The turn to speak is granted by pressing the push-to-talk key on a first come first served basis or based on priorities. Push-to-talk calls are usually connected without the recipient answering and typically received through the phone's built in loud speaker. Bi-directional communication may be offered since all parties of the communication session may similarly communicate voice data with the PoC application servers. Turns to speak are requested by activating the push to talk button or the like. The response time of connection is almost instantaneous.

As this system is integrated within the cellular telecommunication system this provides a coverage area greater than that provided using traditional two-way radio systems. The push-to-talk service may be implemented using push-to-talk servers in an IP multimedia subsystem (IMS) system. The push to talk service is based on multi-unicasting. Each transmitting handset typically sends packet data traffic to a dedicated push-to-talk server, referred to as home PoC server or the participating function. A participating server sends the packet data traffic further to the controlling server or controlling function that is an entity, which manages the shared floor for a one-to-one and group calls. In a group call the controlling server also duplicates the traffic to be received by all recipients. No multi-casting is performed either in the GPRS access network or over the radio access network.

The push to talk over cellular telecommunication system such are described in more detail in the push to talk over cellular draft provisions such as the ‘OMA Push to talk over Cellular (PoC)-Architecture’.

Groups of communicating user equipment using the PoC system can be created in various ways. The Internet Engineering Task Force (IETF) defines one such system using session initiation protocol (SIP) or Conference Policy Control Protocol (CPCP). Voice and data control traffic once the groups are set up is carried through a real time protocol (RTP) based on those described in IETF RFC 3550. The RTP protocol describes the architecture of the data packets and the syntax of the data stored within the packets passing the voice and data information from user to user.

When a communication session is being set up, the parties involved need to be aware of various parameters to be able to communicate. An example of the parameters is the codec or codecs that shall be used for the communication in a session. A user equipment may support and negotiate multiple codecs for a session. Changing the codec used can be made dynamically within a session, but there are limitations set by various IETF specifications such as internet drafts related to Session Description Protocol (SDP) negotiations and multiparty conferences. In a one-to-one session, if basic SIP/SDP offer-answer model is followed and the negotiation is performed as end-to-end, then both originating client and terminating client have exchanged their codec information. In this case both parties of the conference know the codec(s) that can be used and also in this case the codec can be changed dynamically during the session.

The above described example represents a simple case where there are only two participants in the session. This, in principle, enables following and using an end-to-end offer-answer procedure. However, there are numerous other cases which are more complicated, and end-to-end offer-answer procedures cannot be used or are not feasible anymore.

In a multiparty session, such as a conference call, the message flow is different since it is not possible, or in some cases even feasible to negotiate the parameters such as the codecs by means of end-to-end sessions between the parties. The multi-party sessions are thus handled by intermediate controller entities such as conference servers. A conference server may create ad-hoc conferences. Once the conference server has created the ad-hoc conference and has attempted to add the initial set of participants, the conference server behaves as a regular conference server and follows appropriate rules.

A problem is that a conference server may send an answer to A-party and indicate the selected codec before actually having knowledge of the codec(s) the other parties actually support. More particularly, according to the current IETF drafts in a session setup, at the originating end, the participating function shall respond an ‘INVITE’ message from originating client A immediately with a ‘200 OK’ message. The ‘INVITE’ message from the originating client A contains the SDP offer of media parameters. These parameters can relate, for example, to codecs and codec modes offered by client A for that particular session. The ‘200 OK’ message (or ‘SIP 202 Accepted’ message) with answered media parameters shall then be sent immediately without waiting any response from terminated end.

As the ‘200 OK’ message is sent backwards to the client A immediately, the conference server cannot have any information/knowledge on the capabilities of the terminated end i.e. whether media parameters offered and already answered towards client A are acceptable to terminated end, for example to the participating function of client B and/or client B.

When a response finally arrives from the terminated end to the originating end, typically first the controlling function and then the participating function A, the SDP may contain parameters that are not the same, that have already been answered and accepted towards client A.

In such case the participating function A may need to perform transcoding from RTP media sent by client A to a RTP media format that would be acceptable for terminated end, for example participating function B or client B. In other words, the conference server may need to implement transcoding. This is computationally heavy and complex to implement. Furthermore, the transcoding typically decreases the voice quality. An option for participating function A would be to initiate a session modification procedure e.g. with SIP ‘Update’ or ‘re-INVITE’ to renegotiate the settings with client A. Procedures such as re-negotiation and session modification procedure are, however, time consuming and would therefore degrade the quality perception of the session participants. It is also possible to use single mandatory codec in the network, more particularly in the terminals. However, this may take away the flexibility obtained by support of multiple codecs.

It is also possible that the multiparty session is initiated by a network element. For example, a timer may trigger the request for a multiparty session. It is also possible that a party initiates the session by means of another protocol than the SIP, in which case the first SIP request would come from a server in the network. Regardless the origin of the request, the problems described above in the context of user equipment originated requests may occur.

It is the aim of embodiment of the present invention to address or at least mitigate the problems described above.

### SUMMARY OF THE INVENTION

In accordance with an embodiment, a controller for controlling a multiparty session in a communication system is provided. The controller comprises a control function configured to host a multiparty session, to control joining of parties to the multiparty session, to select at least one communication parameter based on discovered capabilities of the parties to the multiparty session, and to send information regarding the selected at least one communication parameter to at least one party of the multiparty session.

In accordance with an embodiment, there is provided a method in a controller for a communication system. The method comprises hosting a multiparty session, discovering capabilities of the parties to the multiparty session, selecting at least one communication parameter based on the discovered capabilities of the parties, and sending information regarding the selected at least one communication parameter to at least one party of the multiparty session.

In accordance with an embodiment, there is provided a user equipment configured to join a session provided by means of a communication system. The user equipment comprises controller means for processing communication of information regarding a set of parameters for use in the session and for determining from a user plane message information regarding a parameter for use in the session.

In accordance with an embodiment, there is provided a method for a communication system, the method comprising the steps of hosting a half-duplex multiparty session, discovering media parameter capabilities of user equipments participating the session, selecting at least one communication parameter based on the discovered capabilities, and sending information regarding the selected at least one communication parameter to at least one of the user equipments in a media burst control message.

In accordance with a possible embodiment, there is provided a method in a controller and a controller wherein the controller sends information regarding the selected at least one communication parameter by means of a user plane protocol and controls the joining and/or leaving of the parties to the session by means of a control plane protocol. The user plane protocol may comprise a floor control protocol or similar.

Said information regarding the selected at least one communication parameter may comprise information regarding at least one codec.

Said multiparty session may comprise a half-duplex session.

The embodiments of the invention may provide a way of avoiding renegotiations and/or transcending of parameters for multi-party sessions. The session set-up may be made quicker. Session set-up or change of the session parameters may be made by means of a less complex protocol than what is used for the session. The codec used for the session, or any other appropriate parameter, may be changed easily during the session.

### BRIEF DESCRIPTION OF THE DRAWINGS

For a better understanding of the present invention and how the same may be carried into effect, reference will now be made by way of example only to the accompanying drawings in which:

FIG. 1 shows a schematic view of a typical communications network incorporating an embodiment of the present invention;

FIG. 2 shows a schematic view of the push-to-talk communications network as implemented within the communications network of FIG. 1; and

FIG. 3 shows a message flow diagram showing a floor control procedure incorporating an embodiment of the present invention.

### DETAILED DESCRIPTION OF EMBODIMENTS OF THE PRESENT INVENTION

Certain embodiments of the present invention will now be described by way of example, with reference to the exemplifying architecture of a third generation (3G mobile communication system). However it will be understood that embodiments may be applied to any other suitable forms of communication system that he one illustrated and described herein. More particularly, the following example relates to SIP conferencing by means of OMA (Open Mobile Alliance) specified Push-to-talk over Cellular (PoC) Service, and especially to media parameter negotiation procedure where information on the session media parameters are exchanged between the participants and servers. The information to be exchanged may comprise information regarding a codec, codec modes, number of speech frames into RTP packets, port numbers and so forth.

To assist in understanding the invention, an explanation of a possible underlying communication system is given first with reference to element as defined by the third generation partnership project (3GPP). In an architecture for the third generation (3G) core network provides users of user equipment with access to multimedia services. This core network is divided into three principal domains. These are the circuit switched (CS) domain, the packet switched (PS) domain and the internet protocol multimedia subsystem (IMS) domain.

The last mentioned is for providing IP multimedia functionalities. The IMS includes various network entities for the provision of multimedia services. IMS services are intended to offer, amongst other services, IP based packet data communication sessions between mobile user equipment.

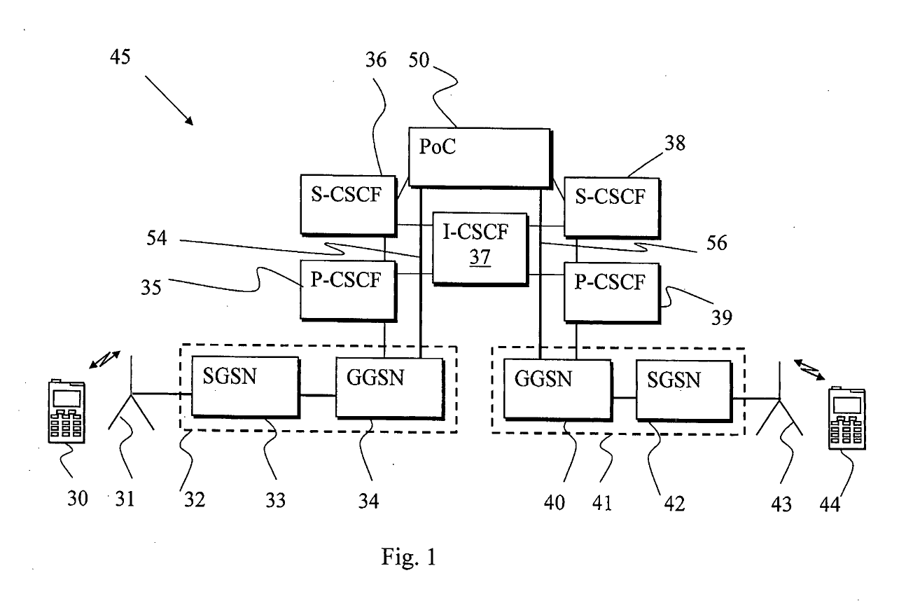

FIG. 1 shows an IP multimedia network 45 for offering IP multimedia services to IP multimedia network subscribers. IP multimedia subsystem (IMS) functionalities may be provided by a core network (CN) subsystem including various entities for the provision of the service. The third generation partnership project (3GPP) has defined it possible to use the general packet radio service (GPRS) for offering IP connectivity to IMS services. Accordingly, a GPRS based system will be used in the following example of a possible backbone communication network enabling the IMS services.

A mobile communication system such as the 3G cellular system is typically arranged to serve a plurality of mobile user equipment, usually via a wireless interface between the user equipment and base stations of the communication system. In FIG. 1, the intermediate mobile communication network provides packet switched data transmission in the packet switched domain between a support node 33,42 and mobile user equipment 30,44. Different sub-networks are in turn connected to an external data network, for example to a packet switched data network (PSDN) via gateway GPRS support nodes (GGSN) 34, 40. The GPRS services thus allow transmission of packet data between mobile data terminals and/or external data networks. More particularly, the exemplifying general packet radio services operation environment comprises one or more sub network service areas, which are interconnected by GPRS back bone networks 32 and 41. A sub-network comprises a number of packet data service nodes (SN). In this embodiment, the service nodes will be referred to as serving GPRS support nodes (SGSN). Each of the SGSNs 33, 42 is connected to at least one mobile communication network, typically to base station systems 31,43. The base stations 31 and 43 are arranged to transmit signals to and receive signals from mobile user equipment 30 and 44 of mobile users i.e. subscribers, via respective wireless interfaces. Correspondingly, each of the mobile user equipment is able to transmit signals to and receive signals from the base stations via the wireless interface. Each of the user equipment 30 and 44 may thus access the IMS network 45. It should be appreciated that, although FIG. 1 only shows the base stations of two radio access networks, a typical mobile communication network usually includes a number of radio access networks.

The IMS domain is for ensuring that multimedia services are adequately managed. The IMS domain commonly supports the session initiation protocol (SIP) as developed by the internet engineering task force (IETF). Session initiation protocol (SIP) is an application-layer control protocol for creating, modifying and terminating sessions with one or more participants (end point). SIP was generally developed to allow for the initiation of a session between two or more end points in the Internet by making these end points aware of the session semantics. A user connected to an SIP base communication system may communicate with various entities of the communication system based on standardised SIP messages. User equipment or users that run certain applications on the user equipment are registered with the SIP backbone so that an invitation to a particular session can be correctly delivered to these end points. SIP provides a registration mechanism for devices and users and it applies mechanisms such as location servers and registrars to route the session invitations appropriately. Examples of proper possible sessions that may be provided by SIP signalling include internet multimedia conferences, internet telephone calls and multimedia distribution.

User equipment within the radio access network may communicate with a radio network controller via radio network channels which are typically referred to as radio bearers. Each user equipment may have one or more radio channels open at any one time with the radio network controller. Any appropriate mobile user equipment adapted for internet protocol (IP) communication maybe used to connect to the network. For example, a user may access the cellular network by means of user equipment such as a personal computer, personal data assistant (PDA), mobile station (MS), portable computer, combinations thereof or the like.

User equipment is used for tasks such as making and receiving phone calls, for receiving and sending data from and to a network and for experiencing for example multimedia content. User equipment is typically provided with a processor and memory for accomplishing these tasks. User equipment may include an antenna for wirelessly receiving and transmitting signals from and to base stations of the mobile communication network. User equipment may also be provided with a display for displaying images and other graphical information for the user of the mobile user equipment. A speaker may also be provided. The operation of the user equipment may be controlled by means of a suitable user interface such as key pad, voice commands, touch sensitive screen or pad, combinations thereof or the like.

The user equipment 30 and 44 of FIG. 1 are configured to enable the use of push to talk types of services. An actuation means that may be required by a push to talk service can be provided, for example, by one of the buttons on the keypad of the mobile station 30 and 44 or by a specific key or button such as the type known from—‘walkie-talkie’ devices. It should be appreciated that FIG. 1 only shows two user equipment for clarity. In practice, a number of user equipment may be in simultaneous communication with each other.

Overall communication between user equipment in an access entity and the GGSN is provided by a PDP context. Each PDP context provides a communication pathway between a particular user and a GGSN. Once the PDP context is established, it can typically carry multiple flows. Each flow normally represents, for example, a particular service and/or media component of a particular service. The PDP context therefore often represents a logical communication pathway for one or more flows across the network. To implement the PDP context between user equipment and the serving GPRS support node, radio access bearers need to be established which commonly allow for data transfer for the user equipment.

Communication systems have developed such that services may be provided for user equipment by means of various functions of the IMS network 45 that are handled by network entities and served by the servers. In the current 3G wireless multimedia network architectures, it is assumed that several different servers are for handling different functions. These include functions such as the call session control functions (CSCF). The call session control functions can be divided into various categories such as a proxy call session control function (P-CSCF) 35, 39, interrogating call session control function (I-CSCF) 37 and serving call session control function (S-CSCF) 36, 38.

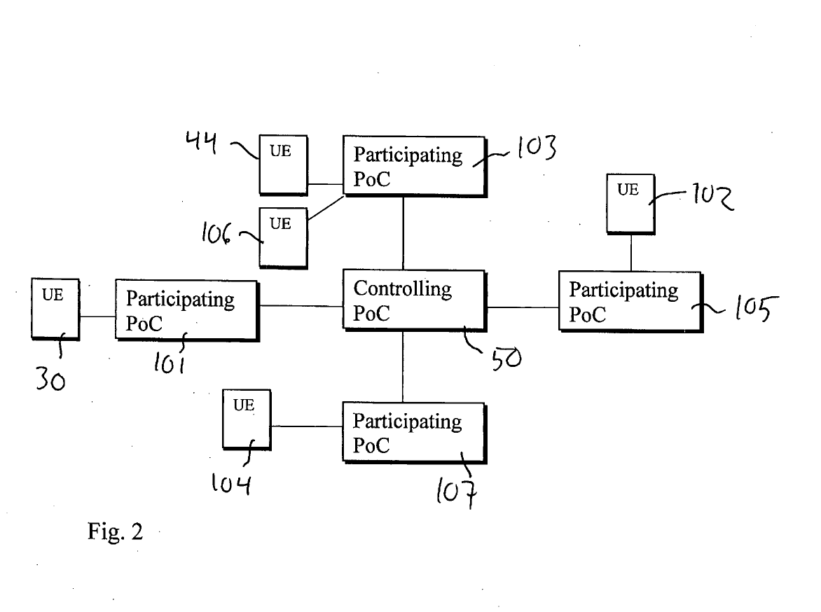

A push-to-talk-over cellular (PoC) session may be hosted by an appropriate application server, such as server 50 of FIG. 1. The user equipment 30, 44 may connect via the GPRS network to application servers that are generally connected to the IMS. FIG. 2 shows a further view of the communications system of FIG. 1 with regards to the push-to-talk over cellular (PoC) system. The following uses terms PoC Server A, PoC server B, participating function (PF) A and controlling function (CF) since these terms are based on the definitions of the current OMA PoC specifications. In these specifications the PoC Server is divided to different functional entities i.e. there is specified participating function (PF) and controlling function (CF) separately, even though the PF and CF may reside in same PoC server.

It is commonly understood that the participating function is the first PoC server contacted by a client or in contact with a client i.e. a client is always in contact with its own, typically home operator's participating function. The controlling function is the one which takes control over the session. In one-to-one sessions the participating function of client A, i.e in the originating end, is also the controlling function. It could be said that PoC server A in these cases is both PF A and CF and typically they reside in same PoC server. For clarity, FIG. 2 shows the participating and controlling functions as being provided by separate servers. Whether a certain PoC server acts as a PF or CF for a session depends on its logical role in the session.

The PoC server can in some embodiments of the present invention be implemented as server means comprising a series of participating PoC servers connected to a controlling PoC server. The participating PoC servers transmit and receive data traffic from the user equipment and also transmit and receive data traffic from the controlling PoC server. The controlling PoC server transmits and receives data traffic from the participating PoC servers and controls access to the PoC shared floor dependent on the information received from the participating servers. In an embodiment of the present invention one participating PoC server also acts as a controlling PoC server.

FIG. 2 shows a plurality of user equipment units communicating over a push-to-talk over cellular telecommunication system. UE 30 is connected to the first participating function (PF), i.e. a participating PoC server 101, which is connected to a controlling function (CF) provided by a controlling PoC server 50. UE 44 and UE 106 are connected to the second participating PoC server 103 which is connected to the controlling PoC server 50. UE 102 is connected to the third participating PoC server 105 which is connected to the controlling PoC server 50. UE 104 is connected to the fourth participating PoC server 107 which is connected to the controlling PoC server 50. In such a system the mobile user equipments can be subscribers of a number of different, e.g. four different IMS networks.

The PoC participating servers 101, 103, 105, 107 and controlling PoC server 50 provide push-to-talk over cellular (PoC) services over the IMS network 45. The push-to-talk service is an example of the so called direct voice communication service. Users who wish to use the PoC service may need to subscribe to an appropriate PoC server.

The direct voice communication services are intended to use the capabilities of the GPRS back bone and the control functions of the multimedia subsystem for enabling IP connections with the user equipment UE 30, UE 44, UE 102, UE 104. The PoC server may be operated by the operator of the IMS system or a third party service provider.

A user may open the communication link, for example, by pressing a specific activation button on the user equipment UE 30. While the user of the UE 30 speaks, the users of UE 44, UE 102, UE 104, and UE 106 listen. The user of the user equipment UE 44 may then reply in a similar manner. The signalling between the user equipment and the appropriate call session control functions is routed via the GPRS network. The user plane session sets up signalling for the user equipment and is routed via the participating PoC servers 101, 103, 105, 107 and hosted by the controlling PoC server 50. In other words, the PoC server controls both the control plane (for signalling) and the User plane (for user data) of the PoC user. The control plane traffic between the participating PoC server and the user equipment may be routed via the IMS whilst the user plane traffic between the user equipment and the PoC server may be routed from the GPRS system to the PoC server on interfaces 54 and 56 (as shown in FIG. 1). Once a push-to-talk session is established using the SIP, a floor control protocol may be used to control the user plane during the session.

As discussed earlier the push-to-talk service is based on multi-unicasting. Each transmitting user equipment sends packet data traffic to a dedicated push-to-talk server and in case of a group call, the server then duplicates the traffic to all recipients. In order to control the communications system user plane messages can be passed from one user to the rest of the system and vice versa. One type of data communications packet in the user plane is that of informing which user is transmitting or has received permission to use the floor. Before sending user plane data to other members of the group, the user equipment typically needs to request the floor by sending a ‘floor request’ message to a controlling server. This may occur e.g. by the end user pressing a Push-to-Talk button of a terminal device or by means of any other appropriate actuation arrangement. The application server may then grant the floor by returning a ‘floor granted’ message or reject the request by returning a ‘floor rejected’ message if the floor cannot be granted. When the user equipment successfully reserves the floor, the server will send a ‘floor taken’ message to other user equipments. When the user equipment has no more user plane data to send the user equipment releases the floor by sending a ‘floor released’ message to the server. At this point the end user has typically released the Push-to-Talk button of the terminal device. The application server may then send a ‘floor released’ message to the other user equipments and the floor is again free to be reserved by someone else. The messages may be communicated by means of appropriate control packets, for example based on real time control protocol (RTCP), this being a subset of the real time protocols (RTP) described earlier. Any other appropriate control protocol may be used fir this purpose.

Having now described the basic architecture of a communication system facilitating multi-party sessions by means of a PoC service, an embodiment of the invention wherein an indication of appropriate codec or codec mode is included in a protocol message, such as any of above described floor control messages sent by the server, that is different from the protocol used for handling the set-up, joining and release of a multiparty session.

In an embodiment a controlling entity such as a controlling conference server may indicate the codec to be used after it has discovered the codecs that are supported by parties that are joining the session. The indication may be sent to the originator of the session by including the indication in a floor control message instead of performing any SIP level session modification procedure. The codec, codec mode or any other parameter that is to be informed, is preferably a subset of the earlier negotiated media parameters. In the PoC these parameters are typically negotiated on the control plane using SIP when the user in question joins the session. If the parameter is not a part of the earlier negotiated codecs, for example, it may thus require a SIP session modification.

The Floor Control protocol may use any appropriate underlying protocol for this purpose, and preferably uses a protocol other than the SIP. For example, RTCP, modified RTCP, XCON, or similar may be used. This is possible in current version of the POC specification since the Talk Burst Control Protocol is based on use of RTCP APP packets (Application-defined RTCP packet), and is specified in OMA PoC specifications. However, it is noted that the operation may be based on other protocols, for example the XCON protocol.

In the herein described PoC related embodiment information, such as an appropriate indication of the selected codec, may be added into a message such as ‘Floor Control’ or ‘Talk Burst Control’. For example, the participating function A may add information such as the RTP payload type (PT) that has been negotiated with SIP/SDP earlier for that particular codec (for example PT=“99”), or any other information that relates to Enhanced Variable Rate Coder (EVRC) as earlier answered in SDP of a SIP message to client A. The information may also be a number indicative of which codec should be selected from the list of preferred codecs (e.g. 2, if the EVRC was the second codec in a row indicated to client A). Any other indication referring to the EVRC may be sent.

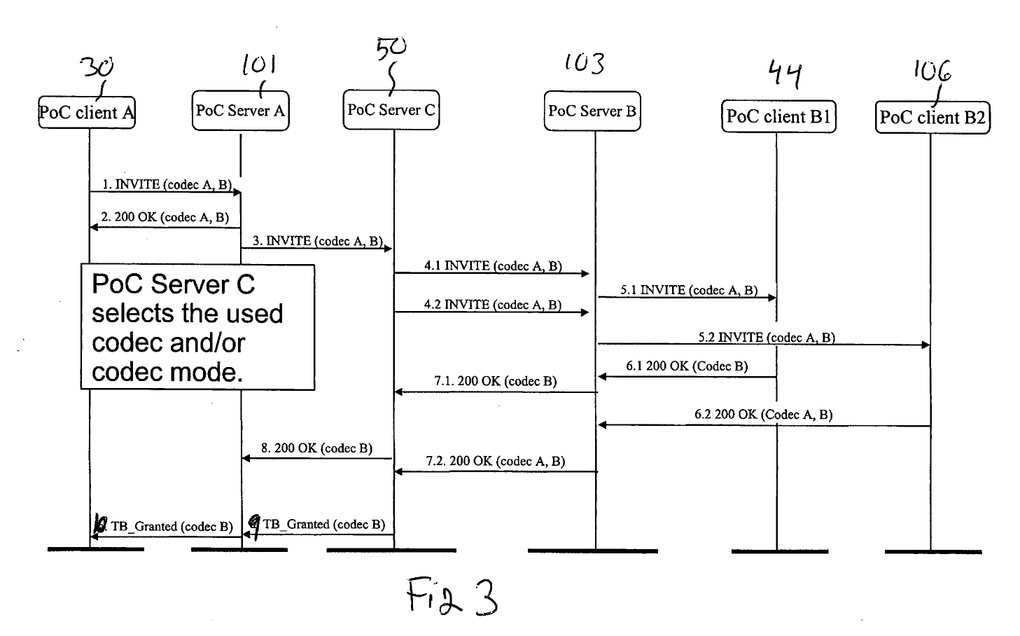

FIG. 3 shows a messaging flow for a communication session involving three clients 30 (client A), 44 (Client B1) and 106 (client B2) and three PoC servers 50, 101, and 103. PoC Server A 30 provides the participating function for the originating client A, PoC Server C 50 provides the controlling function for the session, and PoC Server B 103 provides the participating function for clients B1 and B2.

Although shown as separate entities, the PoC server A and PoC Server C may be provided by a server, i.e. the participating function of client A may provide also the controlling function. It is understood that the split between participating and controlling function is a functional rather than a physical split.

The Client A sends ‘SIP INVITE’ (or ‘SIP REFER’) message 1 to PoC server A. PoC server A immediately answers back with ‘200 OK’ (or ‘202 ACCEPTED’) message 2 to Client A, thus accepting the session description protocol (SDP) offer as proposed by Client A. The SDP offer and answer messages include information indicative that codecs A and B can be used.

It is noted that according to IETF RFC 3264 “An Offer/Answer Model with the Session Description Protocol (SDP)” the codecs are recommended to be listed in preferred order. When indicating A and B in this particular order, it means that unless other information is obtained, the use of codec A is preferred, and should thus be used.

Session set-up may then continue in accordance with the SIP Offer/Answer Model, and messages 3, 4.1, 5.1, 4.2, and 5.2 are sent. In a later phase Client B1 sends a ‘200 OK’ message 6.1, wherein only indication of codec B is included in the SDP offer. The ‘200 Ok’ message is then passed to PoC Server C as message 7.1. Since PoC server realizes that only one option is now available, the PoC Server C may include an indication or command “codec B” into a ‘TB Granted’ message 9. This selection may happen even though message 7.2 informs the PoC server C that PoC client B2 supports codecs A and B. The selection should then happen immediately after realization that only one option remains, i.e. this can be considered as further instructions from controlling function for that session.

When client A receives the ‘TB granted’ message 10, it can recognize an indication that codec B should be used. Client A may then initiate media encoding with correct codec, i.e. codec B instead of for example following the preferred order as stipulated by RFC3264. At this stage client A may check that the codec indicated in a floor control message is one of the accepted codecs of earlier performed SIP set up, see messages 1 and 2.

So based on information obtained from other session participants, the controlling function makes a decision to send information to client A regarding a particular codec to be used. The discovery may be based on the list that was earlier indicated to originating client in SDP of SIP level message. The controlling function can insert that information in Talk Burst Control Protocol message, or any other Floor Control message. The message also preferably carries other data so that no new messages are required. The messages may be transported by means of any appropriate underlying protocol.

It is noted that the request triggering a multiparty session may come from elsewhere than the participants. For example, an element of the network may request for a session. Moreover, each participant may join a multiparty session either by using dial-in or dial-out mechanism. ‘Dial-in’ refers to a mechanism wherein a user equipment sends an SIP ‘INVITE’ message to a conference server which then accepts the invitation by sending a SIP ‘200 OK’ message to the user equipment. ‘Dial-out’ refers to a mechanism wherein a conference server sends a SIP ‘INVITE’ message to a user equipment which may then accept the invitation by sending a SIP ‘200 OK’ message to the conference server. In both cases Session Descriptions (SDP) are exchanged in SIP messages and the conference server becomes aware of the capabilities of the user equipments, e.g. supported codecs, during the negotiations.

A set of suitable codecs may thus be negotiated with each user equipment when the user equipment in question is joining the session, preferably in the beginning of the session. When the controlling function gets a better knowledge of the codecs supported by each user equipment joining the session, either at the beginning or later, it may indicate the actual codec to the user equipments in floor control messages. This gives the controlling function the ability to indicate to user equipments a codec to be used or change the codec without initiating a time consuming SIP layer negotiation procedure.

Similar operation can be applied to other required parameters, such as the codec mode. For example, in adaptive multi-rate (AMR) systems different codec modes such as AMR4.75, AMR5.15, AMR5.9, AMR6.7, AMR7.4, AMR7.95, AMR10.2 and AMR12.2 can be used. These may be indicated according to IETF 3267 with mode-set parameter that are indexes from 0 to 8. E.g. mode-set: 1,2,7 corresponds with AMR5.15, AMR5.9 and AMR12.2. If a response with SDP indicates AMR modes 2,7 supported from terminated end clients and/or servers, and the PF A had answered to client A with AMR mode-set 1,2,7, now in this case there could be indicated “mode-set”=2 towards Client A in the ‘Talk Burst Granted’ message or equivalent. Any other indication referring to that particular codec mode may also be used.

Transmission of information such as the codec information in floor control messages such as ‘TB Granted’, ‘TB Connected’ or ‘TB Taken’ may also provide some additional benefits to those already mentioned above. For example, the codec and/or codec mode information can be provided efficiently and dynamically within a session establishment procedure to all session participants. The codec and/or codec mode information can be provided efficiently and dynamically within a session also if there is need to update the codec and/or codec mode used in that particular session. This may be required e.g. if a new participant joins the session and uses different codec setting that has been used in the session so far. In other words, provision of information of communication parameters such as codecs and/or codec modes is beneficial towards any client in a session, not just the originator. Efficient and dynamic change of a parameter used in session may be provided if this is needed for any reason amongst already negotiated parameters.

Furthermore, by indicating the used codec in messages such as in Floor control messages may enable terminals and servers to use single RTP port for different codecs. In other words, there may be no need to use separate ports for different codecs if the codec to be used is indicated by floor control messages. Typically, if two different codecs are used, they require their own RTP ports negotiated in SDP negotiations, for example there may be a RTP port 3456 for AMR and a RTP port 3466 for EVRC negotiated. Both of these ports need to be reserved and active. With the possibility to indicate the used codec in floor control level messages, the same port can be used for both codecs, because a second, different port is not needed to be able to separate the codec that is used. In this case the original SDP could go as follows i.e. both codecs would use same RTP port. If clients and server can rely that they will receive information regarding the codec(s) in floor control and/or TB control messages, then a port can be used for any negotiated codec since the clients and servers may receive early enough the information and may prepare e.g. the required speech coding vector tables.

It is noted that the parameter information may be indicated in any floor control message, the above mentioned being only examples.

Use of a different protocol for indicating a codec or other parameter to be used for the session provided various advantages, most notably a lighter procedure for the set-up of a session and/or change of the codec or parameter during the session. A half-duplex conference session typically uses a floor control mechanism, these being light and quick compared to protocols such as the SIP. By means of floor control it is possible to indicate a codec and force a codec change without the need to negotiate, thus avoiding exchange of further messages and delay. A further advantage may be provided because SIP messages are typically exchanged only when a user equipment is joining the session or leaving the session, and thus these messages are not available during the session, which can be addressed by means of the floor control messages that can be are exchanged every time one of the user equipments wants to send user plane traffic. This is the case e.g. when a codec will be used.

User equipment may first join a session and negotiate a set of suitable parameters within a session set up. Then the user equipment may receive in a user plane message an indication of a final selection which parameter is to be used. It may then check that the indicated parameter is one of parameters that were allowed during the negotiation phase.

A controlling conference server may have logic for managing supported codecs of each participating user equipment. The logic may observe supported codecs of each joining and leaving user equipment and re-define the most suitable codec to be used after every change in the conference. If the server finds a better codec it may inform it to each user equipment in the next floor control messages. Hence, no extra messages may need to be generated to the network because of the codec change.

The required data processing functions may be provided by means of one or more data processor entities. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

It is understood that other embodiments of the invention are possible, while remaining within the scope of the invention. It is noted that even though the exemplifying communication system shown and described in more detail in this disclosure uses the terminology of the 3^{rd} generation (3G) WCDMA (Wideband Code Division Multiple Access) networks, such as the GSM, UMTS (Universal Mobile Telecommunications System) or CDMA2000 public land mobile networks (PLMN), embodiments of the proposed solution can be used in any communication system providing wireless access for users thereof wherein access of any user equipment may need to be somehow controlled. Whilst embodiments of the present invention have been described in relation to user equipment such as mobile telephones, embodiments of the present invention are applicable to any other suitable type of user equipment that may be used for wireless access. Furthermore, the invention is not limited to OMA PoC environments.

It is also noted herein that while the above describes exemplifying embodiments of the invention, there are several variations and modifications which may be made to the disclosed solution without departing from the scope of the present invention as defined in the appended claims.

1. A controller for controlling a multiparty session in a communication system, the controller comprising:
a control function configured to host a multiparty session, to control joining of parties to the multiparty session, to select at least one communication parameter based on discovered capabilities of the parties to the multiparty session, and to send information regarding the selected at least one communication parameter to at least one party of the multiparty session.

2. A controller as claimed in claim 1, wherein the control function is further configured to send said information regarding the selected at least one communication parameter using a user plane protocol and to control the joining of the parties to the multiparty session using a control plane protocol.

3. A controller as claimed in claim 2, wherein the user plane protocol comprises a floor control protocol.

4. A controller as claimed in claim 2, wherein said control plane protocol is a session initiation protocol (SIP).

5. A controller as claimed in claim 1, wherein said information regarding the selected at least one communication parameter comprises information regarding at least one codec.

6. A controller as claimed in claim 5, wherein said information regarding at least one codec comprises an indication of the at least one codec to be used or a mode of the at least one codec.

7. A controller as claimed in claim 1, wherein said multiparty session comprises a half-duplex session.

8. A controller as claimed in claim 1, wherein the control function is configured to operate in accordance with an open mobile alliance specifications.

9. A controller as claimed in claim 1, wherein the controller comprises a push-to-talk server.

10. A controller as claimed in claim 1, wherein the control function is configured to include said information regarding the selected at least one communication parameter within a message containing other user plane data.

11. A controller as claimed in claim 1, wherein the controller is configured to perform the parameter selection procedure in response to an event where a new party joins the multiparty session or a party leaves the multiparty session.

12. A communication system, comprising:
a controller controlling a multiparty session in a communication system and comprising a control function configured to host a multiparty session, to control joining of parties to the multiparty session, to select at least one communication parameter based on discovered capabilities of the parties to the multiparty session, and to send information regarding the selected at least one communication parameter to at least one party of the multiparty session.

13. A communication system as claimed in claim 12, further comprising:
at least one network element configured in accordance with at least one specification by a third generation partnership project.

14. A method in a controller for a communication system, comprising the steps of:
hosting a multiparty session;
discovering capabilities of parties to the multiparty session;
selecting at least one communication parameter based on the discovered capabilities of the parties; and
sending information regarding the selected at least one communication parameter to at least one party of the multiparty session.

15. A method as claimed in claim 14, wherein
the step of sending information regarding the selected at least one communication parameter comprises communicating said information on a user plane, and
the step of discovering comprises communicating capability information on a control plane.

16. A method as claimed in claim 15, wherein the step of communicating said information on the user plane comprises communicating said information by means of a floor control protocol.

17. A method as claimed in claim 16, wherein the step of communicating information comprises communication of said information in a talk burst granted message, a talk burst connected message, or a talk burst taken message.

18. A method as claimed in any of claims 14, wherein communication on the control plane comprises communication in accordance with a session initiation protocol (SIP).

19. A method as claimed in any of claims 15, wherein the step of communicating information on the user plane comprises communicating said information regarding at least one codec.

20. A method as claimed in any of claims 14, wherein the step of hosting of the multiparty session comprises hosting a half-duplex session.

21. A method as claimed in any of claims 14, wherein the step of selecting at least one communication parameter is performed during a set-up phase of the multiparty session.

22. A method as claimed in any of claims 14, wherein the step of selecting at least one communication parameter is performed during the multiparty session.

23. A method as claimed in claim 22, wherein the step of selecting at least one communication parameter is performed in response to a new party joining the multiparty session or a party leaving the multiparty session.

24. A method as claimed in any of claims 14, comprising a further step of:
receiving a request for the multiparty session from a user equipment.

25. A method as claimed in any of claims 14, comprising a further step of:
receiving a request for the multiparty session from an element of the communication system.

26. A method as claimed in any of claims 14, further comprising:
using a single real time protocol port for at least two codecs subsequent to receipt of a user plane message including information of a codec to be used.

27. A computer program embodied within a computer readable medium, the computer program being configured to perform the steps of:
hosting a multiparty session;
discovering capabilities of parties to the multiparty session;
selecting at least one communication parameter based on the discovered capabilities of the parties; and
sending information regarding the selected at least one communication parameter to at least one party of the multiparty session.

28. A user equipment configured to join a session provided by means of a communication system, the user equipment comprising:
controller means for processing communication of information regarding a set of parameters for use in the session and for determining from a user plane message said information regarding a parameter for use in the session.

29. A user equipment as claimed in claim 28, wherein the controller means is configured to check whether the parameter received in the user plane message is one of parameters belonging to a negotiated set of parameters.

30. A user equipment as claimed in claim 28, wherein the information regarding the parameter comprises a codec or a codec mode.

31. A user equipment as claimed in any of claims 28, wherein the controller means is further configured to use, subsequent to receipt of the user plane message, a single real time protocol port for at least two codecs.

32. A method for a communication system, comprising the steps of:
hosting a half-duplex multiparty session;
discovering media parameter capabilities of user equipments participating in the half-duplex multiparty session;
selecting at least one communication parameter based on the discovered media parameter capabilities; and
sending information regarding the selected at least one communication parameter to at least one of the user equipments in a media burst control message.

33. A controller for controlling a multiparty session in a communication system, the controller comprising:
control function means configured to host a multiparty session, to control joining of parties to the multiparty session, to select at least one communication parameter based on discovered capabilities of the parties to the multiparty session, and to send information regarding the selected at least one communication parameter to at least one party of the multiparty session.
